(19) United States
(12) Patent Application Publication
(10) Pub. No.: US 2011/0265531 A1
(43) Pub. Date: Nov. 3, 2011

(54) THEFT DETERRENT LOCKING SYSTEM

(75) Inventor: Florian WESTWINKEL, Toronto (CA)

(73) Assignee: WESKO SYSTEMS LIMITED, Mississauga (CA)

(21) Appl. No.: 13/096,021

(22) Filed: Apr. 28, 2011

(30) Foreign Application Priority Data
Apr. 28, 2010 (CA) 2701973

(51) Int. Cl. E05B 25/00; E05B 35/00

(52) U.S. Cl. 70/352; 70/344

(57) ABSTRACT

A cylindrical lock assembly has a locking core which separates into two portions when the locking core is struck along or across its axis. A reinforced barrier is positioned near a break zone between two portions of the locking core to promote separation at the break zone. The lock housing contains the locking core for movement between locked and unlocked positions. An optional reinforced tumbler prevents unauthorized removal of the locking core from the lock housing. The housing includes an optional reinforced section to inhibit unauthorized removal of the locking core from the lock housing. The lock assembly may be used in retrofit and new installations

### FIELD OF THE INVENTION

The present invention relates to locking mechanisms used in filing and storage cabinets, furniture and other lockable storage compartments.

### BACKGROUND OF THE INVENTION

Many known locking systems incorporate rotatable locking cores which engage locking systems within storage compartments provided in cabinets, furniture and other storage units. In many instances, these locking cores may be broken or rendered inoperable by persons attempting to gain unauthorized access to the storage compartments by punching through the locking core with a screw driver, chisel, spike, or other instrument. Vandals and others often insert a tool into the entry of the keyway, through the exposed face of the locking core, to disarm the tumblers within the locking core, thereby gaining access to the internal drive mechanism of the lock apparatus, to unlock the storage compartment. The tool is often used to strike the tumblers, to break and dislodge the tumblers, to provide an unobstructed keyway, allowing the unauthorized person to manipulate the drive mechanism through the unobstructed keyway of the damaged locking core.

There is a need for an improved locking core and locking apparatus with vandal deterrent and theft deterrent features to inhibit unauthorized operation of the locking system and to inhibit access to the corresponding storage compartments.

### SUMMARY OF THE INVENTION

In one aspect, a locking core has a keyway extending along its longitudinal axis. The keyway is provided with a plurality of movable tumblers projecting outwardly from the axis, so that they may engage corresponding tumbler channels in a corresponding lock housing. Some embodiments of the present invention may be utilized in retrofit applications or in original equipment manufacturing operations. The locking cores are often installed in locking systems which include an array of vertically stacked sliding bars, to selectively lock two or more storage compartments in one storage unit. The locking core, when in use and coupled with a driver, activates the locking system to selectively lock and unlock the storage compartments. In some instances, the locking systems are integrated with anti-tip systems to prevent the simultaneous opening of more than one unlocked storage compartment, and thus avoid the storage unit from toppling over during operation.

In one example of the invention, the locking core is elongated and it defines a longitudinal axis extending between a proximate end and a distal end of the locking core. The locking core includes a break zone which is provided between the proximate end and the distal end. The break zone extends across the longitudinal axis. However, skilled persons will understand that in some instances, the break zone may be provided as engineered faults concentrated mostly on one side of the locking core, without necessarily extending those faults through the locking core. The break zone divides the locking core so that, when the locking core is struck with a breaking force, the locking core is separated into at least two portions, including a first portion and second portion. In one aspect, a security barrier is positioned adjacent the break zone, between the break zone and the proximate end. The security barrier extends for open alignment across the keyway so that a properly configured operating key may be fully inserted into the keyway. When an operating key is inserted into the keyway, an opening within the security barrier is aligned with the keyway, to permit entry and egress of the operating key through the keyway. The opening in the security barrier may be partially obstructed by one or more projections to inhibit unauthorized entry into the keyway by improperly configured tools The security barrier may be movable between a first position in which the security barrier is in open alignment with the keyway and a second position in which the security barrier blocks access to the keyway.

In another aspect, the security barrier may be positioned between the break zone and the distal end of the locking core. The security barrier may be reinforced or made of a suitably hardened material, so that the locking core will preferentially separate into the first and second portions, at or near the break zone, when the locking core is struck with a breaking force. In the preferred aspect, the security barrier is configured as a reinforced security plate. In other aspects, the security barrier may be configured in other shapes which are suitable for its intended purpose.

When the operating key is inserted into the keyway during normal operation of the locking core, the operating key extends internally along the length of the locking core, to retract the tumblers into the locking core, to permit rotation of the locking core, within a lock housing included in the locking system, between a locked position and an unlocked position.

In an another embodiment, an optional security tumbler is positioned adjacent the distal end of the locking core, extending in slidable arrangement across the keyway. The security tumbler is provided to inhibit displacement of the distal end of the locking core relative to the distal end of a corresponding lock housing. The security tumbler may slide between two positions, in which the security tumbler blocks the keyway in one position, and the security tumbler providing access to the keyway in the second position. The security tumbler may be configured in various shapes and made of various materials which are suitable for the intended purpose of the security tumbler.

One aspect of the invention provides a locking apparatus including a locking core operable within a suitably configured lock housing. The lock housing defines a retainer section adjacent the distal end to inhibit outward movement of the second core portion of the locking core from the lock housing when the breaking force is applied to the locking core.

Preferably, the locking core is cast from a rigid first material and the security barrier and the optional security tumbler are formed from one or more other materials and are reinforced or hardened, consisting essentially of hardened, resilient steel. In the preferred aspect, the locking core includes a security barrier and a security tumbler. The distal end of the lock housing is also provided with a reinforced retainer section to inhibit displacement of the distal end of the locking core, to disengage the corresponding driver mechanism.

In the preferred embodiment, the security tumbler is retractable from a tumbler channel by use of the operating key. However, in the preferred embodiment the security barrier is not retractable from a tumbler channel. In other aspects, both of the security tumbler and the security barrier may be configured to be retractable from corresponding tumbler channels upon insertion of the operating key into the keyway.

In another aspect, the invention is embodied in a storage unit comprising a storage compartment. The storage compartment includes an embodiment of the locking core as described herein. The storage unit includes a locking mechanism associated with the storage compartment, the locking core is configured in the manner described herein.

Other aspects of the invention will become apparent to those persons who are skilled in the art upon reading the following detailed description, drawings and appended claims.

### IN THE DRAWINGS

FIG. 1 is a frontal view, in partial section, of a preferred embodiment of the present invention including an embodiment of a locking core and lock housing for use in a lock assembly;

FIG. 2 is an exploded perspective view of the illustrated embodiment of the locking core of the invention;

FIG. 3 is a frontal view of a preferred embodiment of the security barrier, namely a plate, provided in the locking core of FIGS. 1 and 2; and

FIG. 4 is a frontal view of the security tumbler provided in the locking core of FIGS. 1 and 2;

### DESCRIPTION OF THE PREFERRED EMBODIMENT OF THE INVENTION

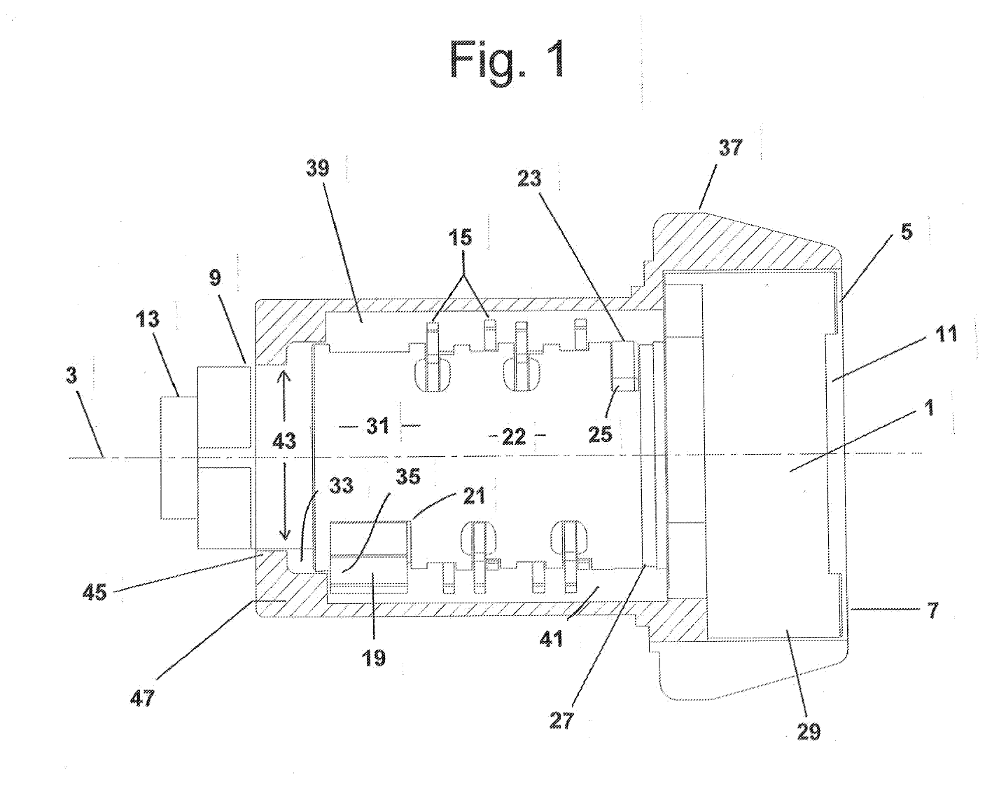

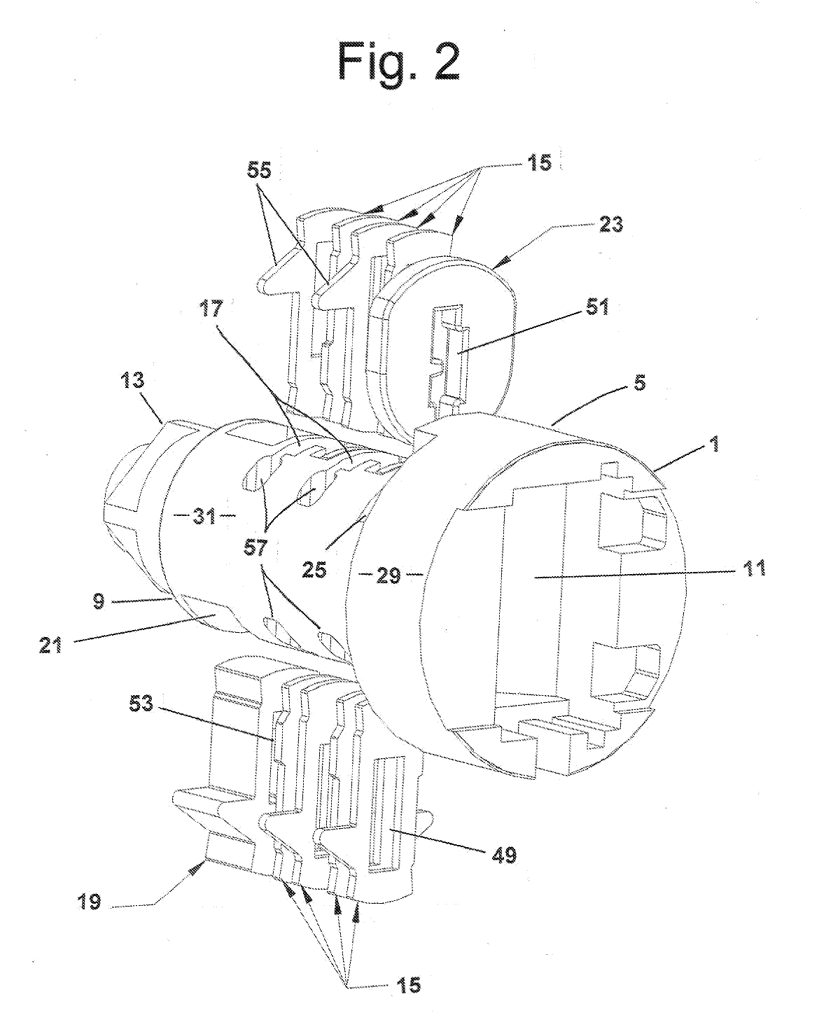

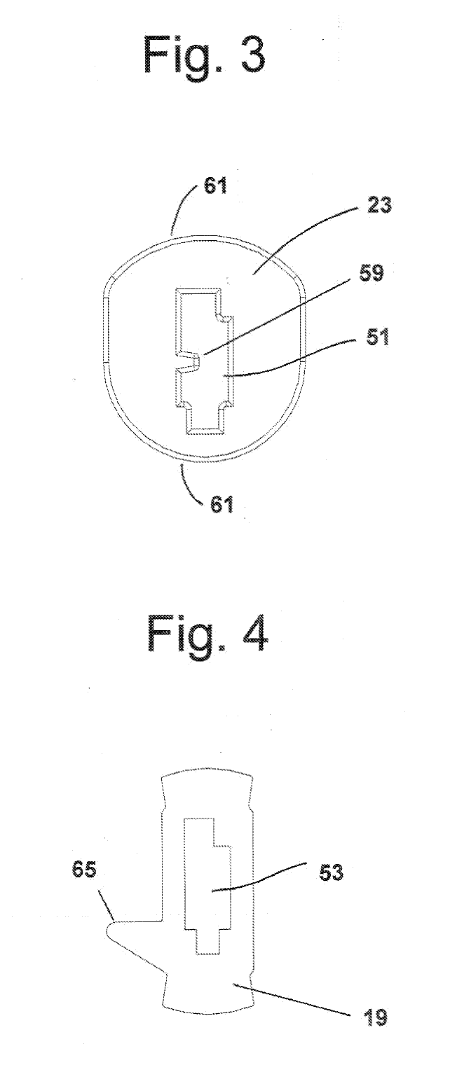

A preferred embodiment of the invention is illustrated in FIGS. 1-4. With reference to FIGS. 1 and 2, a locking core 1 is positioned within a lock housing 37. When in use, locking core 1 rotates about its longitudinal axis 3, within lock housing 37. The core face 7 at the proximate end 5 of locking core 1 defines a keyway 11 which extends along the longitudinal axis 3. A driver 13 is secured at the distal end 9 of the locking core 1 so that upon operational rotation of the locking core 1, other components (not shown) within the lock assembly are activated to lock or unlock corresponding storage compartments (not shown) in a storage unit, including for example, desks, cabinets, credenzas, and other office furniture and storage facilities.

The locking core 1 is provided with upper and lower courses of retractable tumblers 15 housed within corresponding tumbler ports 17 extending along the length of the locking core 1. The tumblers 15 are biased to project outwardly from the locking core 1 by springs (not shown) loaded within spring ports 57. Each tumbler spring (not shown), when compressed within its spring port 57, engages the corresponding tumbler arm 55 to urge the corresponding tumbler 15 outwardly from the locking core 1. Each tumbler 15 defines a tumbler keyway segment 49 to allow an operating key to pass through, and into the keyway 11, to retract the tumbler 15 into the locking core 1.

As shown in FIGS. 1, 2 and 3, a security barrier, provided by a security plate 23 in this embodiment, is slidefit within proximate channel 25 within locking core 1. Security plate 23 defines a security plate keyway segment 51 to accommodate the operating key when it is inserted into the keyway 11 for operation of the locking core 1 between the locked and unlocked positions. Preferably the security plate 23 is provided with rounded upper and lower edges 61 so that the security plate 23 does not inhibit rotational movement of the locking core 1 from the locked position to the unlocked position. When the operating key is inserted into the keyway 11, a guide (groove) in the operating key (not shown) accommodates keyway obstruction 59 to allow further insertion of the operating key toward the distal end of the keyway 11.

The locking core 1 is provided with a break zone, which in this embodiment, is defined by an annular engineered fault line 27 extending about the perimeter of the locking core 1. In the preferred embodiment, the break zone is located adjacent the security barrier, between the security barrier and the proximate end of the locking core 1. When an attempt for unauthorized entry is made by, for example, inserting a slot-screw driver into the keyway, to strike the tumblers with a breaking force to gain operational control of the driver 13, the reinforced security plate 23 inhibits entry of the slot-screw driver beyond the reinforced security plate 23. In this embodiment, keyway obstruction 59 is configured to inhibit entry by a slot-screw driver, blade or other device which is not appropriately keyed to accommodate the keyway obstruction 59. In some embodiments (which are not illustrated), multiple key obstructions may be provided in an offset array, projecting inwardly from opposing sides of the security plate keyway segment.

The security plate 23 is suitably reinforced, so that, an attempted strike by a breaking force applied from the proximate end, along the longitudinal axis, will transmit the force to the security plate 23, causing the locking core 1 to separate at the break zone. In the preferred embodiment, the locking core will separate preferably into two pieces, of which the first portion 29 is at the proximate end of the lock housing 37 and the second portion 31 of the broken locking core is at the distal end of the lock housing 37.

Skilled persons will understand that the security barrier may be a reinforced security plate made of hardened steel or other suitable material, so that it is likely to remain undistorted and in tact, after the locking core is struck in an attempt to gain unauthorized entry into the corresponding locked storage compartment. Similar considerations will be applied when selecting a suitable construction material for the reinforced security tumbler.

When the locking core 1 is struck with a breaking force at or near the security plate 23, separation of the locking core at the fault line 27, into two distinct portions 29, 31, the mechanical connection to the driver 13 is broken, thereby inhibiting unauthorized rotation of the second portion 31, including the driver 13.

The locking core 1 also defines an outwardly extending distal channel 21 to house a reinforced security tumbler 19. The security tumbler 19 defines a security tumbler keyway segment 53 to receive the operating key when it is inserted into the keyway 11, for operation of the locking core 1 between locked and unlocked positions. In the preferred embodiment, the security tumbler 19 is retractable into the lock housing, to permit operational rotation of the locking core 1. The security tumbler 19 is provided with a security tumbler arm 65 which is urged outwardly from the locking core by a security tumbler spring (not shown) installed between the security tumbler arm 65 and an inner core surface (not shown) within the locking core 1. In the locked position, the security tumbler 19 is urged outwardly by the security tumbler spring, to extend into lower tumbler channel 41 to inhibit rotation of the locking core 1 from the locked position to the unlocked position. In this embodiment, when the operating key is fully inserted into the keyway 11, including into security tumbler keyway segment 53, the security tumbler is retracted to permit rotation of the locking core 1.

In the preferred embodiment, the length of the reinforced security tumbler 19 is substantially equal to the diameter of the locking core 1, so that upon full retraction, the opposing ends of the security tumbler are flush with the outer wall of the locking core 1. When the security tumbler 19 is in the locked position, such that one end thereof extends into the lower tumbler channel 41, in abutting relation to a first abutment 47, the reinforced security tumbler 19 extends across the longitudinal axis 3, so that the opposite end of the reinforced security tumbler 19 is located adjacent the opposite side of the lock housing 37. A first wall 35 of the distal end of the locking core 1 abuts against the first abutment 47 of the lock housing 37. The length of the reinforced security tumbler 19 is preferably greater than the diameter of the opening 43 at the distal end 9 of the lock housing 37 so that, if a sudden breaking force is applied to locking core 1, the reinforced security tumbler 19 is likely to remain intact, to inhibit outward displacement of the locking core 1, at the distal end 9 of the lock housing 37. An optional second abutment 45 is also provided to further inhibit unauthorized outward displacement of the locking core 1 by abutting against the optional second wall 33 at the distal end 9 of the lock housing 37.

In this embodiment, the configuration and placement of the reinforced security plate 23 and the reinforced security tumbler 19 tend to enhance preferential crushing of the intermediate portion 22 of the locking core 1 including the tumblers 15 (bounded by security plate 23 and security tumbler 19) when repeated blows are aimed at the locking core 1 along the longitudinal axis 3. That intermediate portion 22 tends to be crushed without dislodging or rotating the driver 13, to further inhibit unauthorized operation of the locking apparatus and to inhibit unauthorized entry to the storage facility.

In other embodiments which are not shown, a variant of the security tumbler 19 will not be retracted by the operating key. The variant of the security tumbler (in embodiments which are not shown) may also function as a retainer to removably secure the locking core within a modified lock housing. During operation of some of these embodiments, the variant of the security tumbler will travel within a corresponding annular channel of the modified lock housing, during rotation of the locking core 1 between the locked and unlocked positions. In some embodiments, a master key (not shown) may be used to fully retract the variant of the security tumbler from the annular recess and into the locking core 1, to permit withdrawal of the locking core 1 from the modified lock housing.

With reference to the embodiment of the invention in FIGS. 1-4, shown in the locked position, the upper and lower courses of tumblers 15 extend outwardly to engage corresponding upper tumbler channel 39 and lower tumbler channel 41 defined within the inner chamber of lock housing 37. When the tumblers 15 are extended into the upper and lower tumbler channels 39, 41, respectively, the locking core 1 is prevented from rotating, thereby preventing rotational movement of the locking apparatus to the open position. Persons skilled in the art will understand that the tumblers 15 may be retracted upon insertion of an operating key (not shown) into the keyway 11, to permit operational rotation of the locking core 1 between the locked and unlocked positions.

Although the preferred embodiment features a security barrier at the distal end in addition to a combined reinforced security tumbler and break zone at the proximate end, other embodiments may be configured to use only one component within a modified lock assembly. For example, a security barrier (which is also designed to operate as a security tumbler) may be provided adjacent the break zone.

Other modified embodiments of the reinforced security tumbler may be configured to retain the distal end of the locking core within the corresponding lock housing of a lock assembly. Similarly, other embodiments of the invention may feature a suitably configured security barrier which is adjacent to the proximate end of the locking core. The security barrier may be positioned between the break zone and the proximate end of the locking core. The locking core may be cast from a relatively inexpensive metal, having suitable material strength characteristics so that the locking core is likely to separate at or near the break zone. The security barrier and the reinforced security tumbler may be made of other metals having superior hardness and other strength characteristics to enhance separation of the locking core at or near the break zone, into at least two major portions.

The break zone may be defined by a relatively weak and narrow band or area extending about or through a defined plane extending across the axis of the locking core, so that the locking core is more likely to separate within that area. The break zone may correspond to one or more holes, channels or depressions which have been cut, cast, drilled, stamped or otherwise formed within a predetermined band extending across the axis of the locking core. Skilled persons will appreciate that a break zone may be provided in many other ways.

Many other variations and modifications of the invention are also possible. The preferred embodiment of the invention has been described with regard to the appended drawings. It will be apparent to those skilled in the art that additional embodiments are possible and that such embodiments will fall within the scope of the appended claims.

1. A locking core defining a longitudinal axis, the core comprising:
a keyway extending along the longitudinal axis between a proximate end of the core and a distal end of the core,
a break zone between the proximate end and the distal end, the break zone extending across the longitudinal axis,
a first core portion extending between the proximate end and the break zone,
a second core portion extending between the break zone and the distal end,
a security barrier positioned adjacent the break zone, the security barrier extending for open alignment across the keyway, and
when the locking core is struck by a breaking force, the first core portion is separated from the second core portion.

2. The locking core claimed in claim 1, the security barrier being positioned between the break zone and the distal end of the core.

3. The locking core claimed in claim 1 comprising a security tumbler adjacent the distal end extending in slidable arrangement across the keyway.

4. The locking core claimed by claim 1, the security barrier is operable across the keyway, between a first barrier position blocking access to the keyway and a second barrier position providing access to the keyway.

5. The locking core claimed in claim 3, the security tumbler operates between a first tumbler position blocking access to the keyway and a second tumbler position providing access to the keyway.

6. A lock assembly comprising the locking core claimed in claim 1 positioned for rotational operation within a lock housing, the lock housing defining a retainer section adjacent the distal end to inhibit outward movement of the second core portion from the lock housing when the breaking force is applied to the locking core.

7. The lock assembly claimed in claim 6, the retainer section comprising an abutment engaging the security tumbler to inhibit outward movement of the second core portion.

8. The lock assembly claimed in claim 7, the retainer section comprising a second abutment to inhibit outward movement of the second core portion.

9. In the locking core claimed in claim 1, one of the security barrier and the security tumbler are retractable to permit withdrawal of the locking core from the lock housing.

10. In the locking core claimed in claim 1, when the first and second core portions are separated, rotation of the second core portion is inhibited during rotation of the first core portion.

11. A storage structure comprising at least one storage compartment, the storage compartment secured against opening by a lock assembly as claimed in claim 6.

12. In the storage structure claimed in claim 11, the lock assembly comprising a driver adjacent the distal end, the driver being in operative association with the second core portion, the driver being inhibited against movement from a locked position to an unlocked position when the first and second core portions are separated.

13. In the storage structure claimed in claim 12, the security barrier defining a barrier opening for open alignment with the keyway, and the security barrier comprising one or more obstructive projections extending into the barrier opening.

14. A locking core defining a longitudinal axis, the core comprising:
a keyway extending along the longitudinal axis between a proximate end of the core and a distal end of the core,
a break zone between the proximate end and the distal end,
a first core portion extending between the proximate end and the break zone,
a second core portion extending between the break zone and the distal end,
a security barrier positioned adjacent the break zone, the security barrier extending for open alignment across the keyway, and
when the locking core is struck by a breaking force, the first core portion is disengaged from the second core portion within the break zone.

15. In the locking core claimed in claim 14, the security barrier is slidably operable across the keyway between a first position blocking access to the keyway and a second position providing open access to the keyway.

16. In the locking core claimed in claim 15, the security barrier is retractable to permit withdrawal of the locking core from the lock housing.

17. A locking core defining a longitudinal axis, the core comprising:
a keyway extending along the longitudinal axis between a proximate end of the core and a distal end of the core,
a break zone between the proximate end and the distal end,
a first core portion extending between the proximate end and the break zone,
a second core portion extending between the break zone and the distal end,
a security barrier adjacent the break zone in open alignment with the keyway when an operating key is inserted into the keyway, and
the first core portion disengages from the second core portion within the break zone when the locking core is struck by a breaking force, to inhibit operation of the second core portion upon operation of the first core portion.

18. The locking core claimed in claim 17, comprising a security tumbler slidably extending across the keyway, and one of the security tumbler and the security barrier are operable to permit withdrawal of the locking core from the lock housing.

19. The locking core claimed in claim 18, the security barrier obstructs the keyway when the first core portion disengages from the second core portion.

20. The locking core claimed in claim 18, the keyway is obstructed when the first portion is disengaged from the second core portion.
